(19) United States
(12) Patent Application Publication
(10) Pub. No.: US 2019/0131705 A1
(43) Pub. Date: May 2, 2019

(54) USER INSENSITIVE PHASED ANTENNA ARRAY DEVICES, SYSTEMS, AND METHODS

(71) Applicant: wiSpry, Inc., Irvine, CA (US)

(72) Inventors: Igor Syrytsin, Aalborg (DK); Shuai Zhang, Aalborg SV (DK); Gert Frølund Pedersen, Storvorde (DK)

(73) Assignee: wiSpry, Inc., Irvine, CA (US)

(21) Appl. No.: 16/157,979

(22) Filed: Oct. 11, 2018

Related U.S. Application Data
(60) Provisional application No. 62/570,916, filed on Oct. 11, 2017.

(51) Int. Cl. H01Q 3/32; H01Q 21/00

(52) U.S. Cl. CPC H01Q 3/32; H01Q 21/0006

(57) ABSTRACT

In some embodiments, a phased antenna array system includes antenna sub-arrays spaced apart from one another about a mobile device chassis, with each of the antenna sub-arrays including one or more antenna element. One or more of the antenna sub-arrays are selectively addressable to generate an aggregate response among a combination of the plurality of antenna sub-arrays to steer one or more signal beam in a desired direction.

### PRIORITY CLAIM

The present application claims the benefit of U.S. Patent Ser. No. 62/570,916, filed Oct. 11, 2017, the disclosure of which is incorporated herein by reference in its entirety.

### TECHNICAL FIELD

The subject matter disclosed herein relates generally to mobile antenna systems and devices.

### BACKGROUND

At centimeter-wave and millimeter-wave frequencies (e.g., about 28 GHz), the shadowing from the user's head, body, and hand have a high impact on the performance of a phased mobile antenna array.

### SUMMARY

In accordance with this disclosure, user insensitive steerable antenna array devices, systems, and methods are provided. In one aspect, a steerable antenna array system includes a plurality of antenna sub-arrays spaced apart from one another about a mobile device chassis, with each of the antenna sub-arrays comprising one or more antenna element. One or more of the plurality of antenna sub-arrays are selectively addressable to steer one or more signal beam in a desired direction.

In another aspect, a method for operating a steerable antenna array is provided, the method including selectively addressing one or more of a plurality of antenna sub-arrays spaced apart from one another about a mobile device chassis, and steering one or more signal beam from the one or more of the plurality of antenna sub-arrays in a desired direction.

Although some of the aspects of the subject matter disclosed herein have been stated hereinabove, and which are achieved in whole or in part by the presently disclosed subject matter, other aspects will become evident as the description proceeds when taken in connection with the accompanying drawings as best described hereinbelow

### BRIEF DESCRIPTION OF THE DRAWINGS

The features and advantages of the present subject matter will be more readily understood from the following detailed description which should be read in conjunction with the accompanying drawings that are given merely by way of explanatory and non-limiting example, and in which:

FIGS. 1A-1C illustrate various schematic plan views of a geometry of an antenna array according to an embodiment of the presently disclosed subject matter;

FIGS. 2A-2C illustrate various plan views of end-fire radiation patterns of an antenna array on a mobile device according to an embodiment of the presently disclosed subject matter;

FIG. 3A is a graph illustrating a scan angle for a single sub-array of an antenna array on a mobile device according to an embodiment of the presently disclosed subject matter;

FIG. 3B is a graph illustrating a scan angle for a pair of adjacent sub-arrays of an antenna array on a mobile device according to an embodiment of the presently disclosed subject matter;

FIGS. 4A-4C are graphs illustrating total scan patterns of an antenna array in free space, in talk mode, and in data mode, respectively, according to an embodiment of the presently disclosed subject matter; and

FIG. 5 is a graph illustrating a comparison of the simulated coverage efficiency for free space, talk, and data modes according to an embodiment of the presently disclosed subject matter.

### DETAILED DESCRIPTION

The present subject matter provides devices, systems, and methods for a steerable antenna array that is insensitive to shadowing from a user's head, body, and/or hand. In one aspect, the present subject matter provides an antenna array that is configured to reduce shadowing effects on the coverage efficiency performance. In some embodiments, the antenna array includes a plurality of sub-arrays located on a ring around the mobile device chassis. In some embodiments, the sub-arrays are arranged at or near corners of the device, such as with one sub-array positioned at or near each end of each edge of the device.

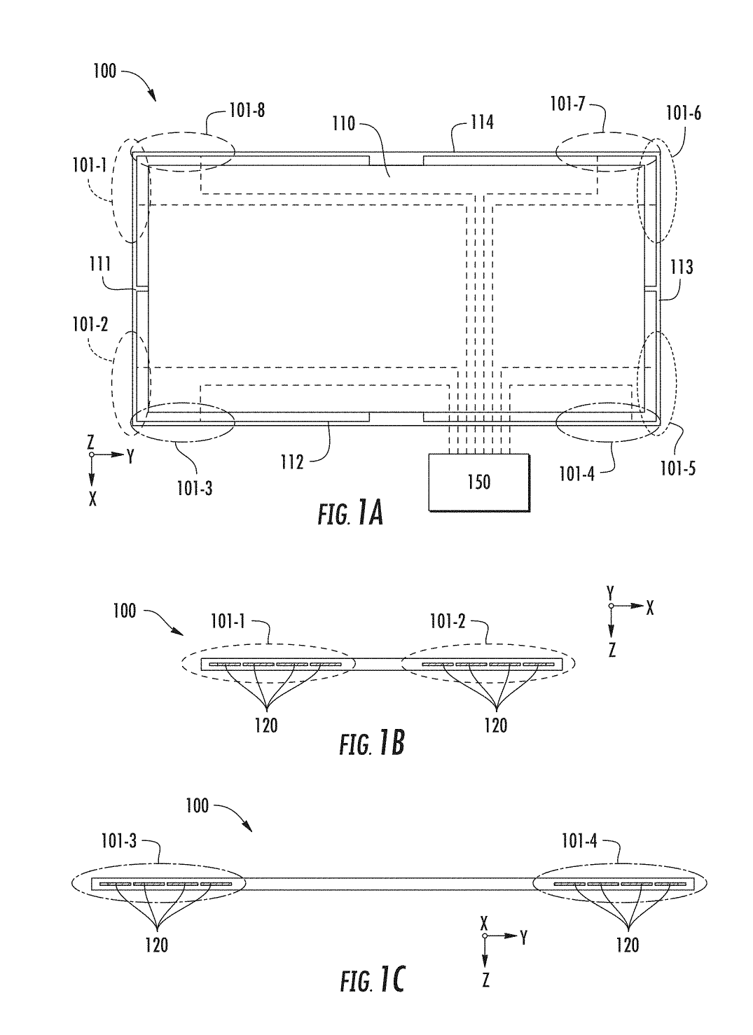

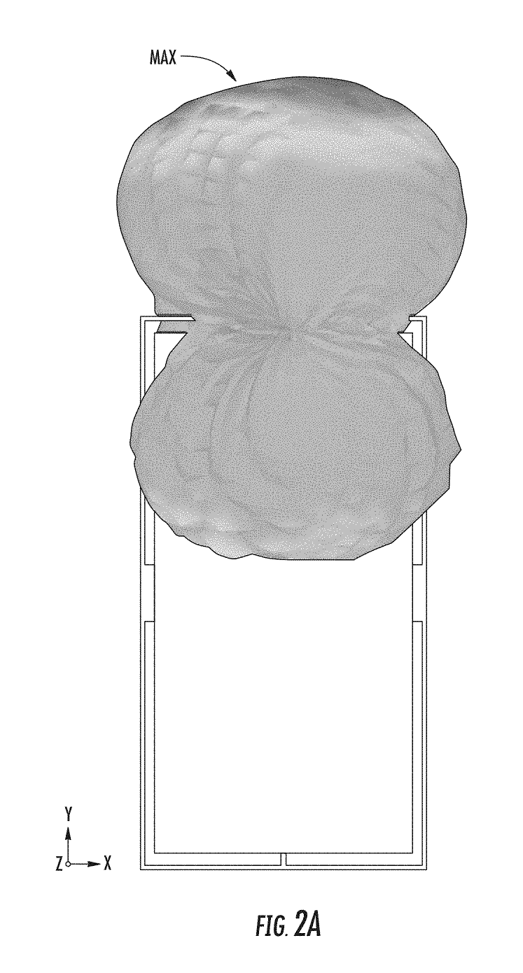

In one embodiment illustrated in FIG. 1A, an exemplary configuration for a steerable antenna array, generally designated 100, includes eight total sub-arrays, with first and second sub-arrays 101-1 and 101-2 being arranged on a first edge 111 of a device chassis 110, third and fourth sub-arrays 101-3 and 101-4 being arranged on a second edge 112 of device chassis 110, fifth and sixth sub-arrays 101-5 and 101-6 being arranged on a third edge 113 of device chassis 110, and seventh and eight sub-arrays 101-7 and 101-8 being arranged on a fourth edge 114 of device chassis 110. Further, in some embodiments, each of first through eight sub-arrays 101-1 through 101-8 are arranged at a respective corner of device chassis 110. Although one particular configuration is illustrated, those having skill in the art will recognize that any of a variety of other numbers of sub-arrays, which can be identified generally as sub-arrays 101-1 through 101-i, or other arrangement or configurations can likewise be used.

Each of sub-arrays 101-1 through 101-i includes one or more antenna elements 120. Referring to the exemplary configuration illustrated in FIGS. 1B and 1C, for example, each of first through fourth sub-arrays 101-1 through 101-4 includes four antenna elements 120. Similarly, although not particularly illustrated, the remaining fifth through eighth sub-arrays 101-5 through 101-8 can likewise include four antenna elements 120. Those having ordinary skill in the art will recognize, however, that each of sub-arrays 101-1 through 101-i can have any of a number of antenna elements 120 as desired for the particular antenna performance.

Regardless of the number or arrangement of sub-arrays 101-1 through 101-i or the number of antenna elements 120 included in each of sub-arrays 101-1 through 101-i, in some embodiments, each of sub-arrays 101-1 through 101-i is operable as an antenna array, wherein a signal wave generated by one of the sub-arrays 101-1 through 101-i is steerable in a desired direction. Alternatively or in addition, in some embodiments, sub-arrays 101-1 through 101-i are configured to be collectively controllable such that a beam generated by the aggregate operation of antenna elements 120 in each of sub-arrays 101-1 through 101-i can be scanned across sub-arrays 101-1 through 101-i. In some embodiments, this selective scanning of sub-arrays 101-1 through 101-i provides diversity among and between sub-arrays 101-1 through 101-i, although it is also possible to use phasing, a lens antenna/switch port configuration, a pattern reconfigurable antenna arrangement, or another mechanism to steer among multiple antenna elements 120 in different sub-arrays. In any configuration, in some embodiments, the relative phase between elements in different sub-arrays—if operated simultaneously at the same carrier frequency—can be controlled through a lower intermediate frequency and aligned digitally on a mobile device in a single communications processor.

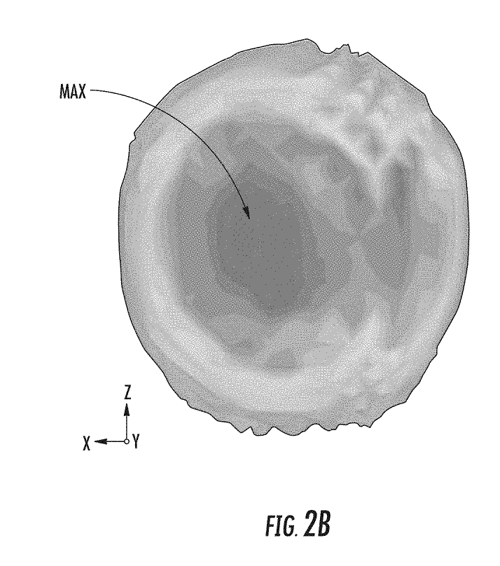

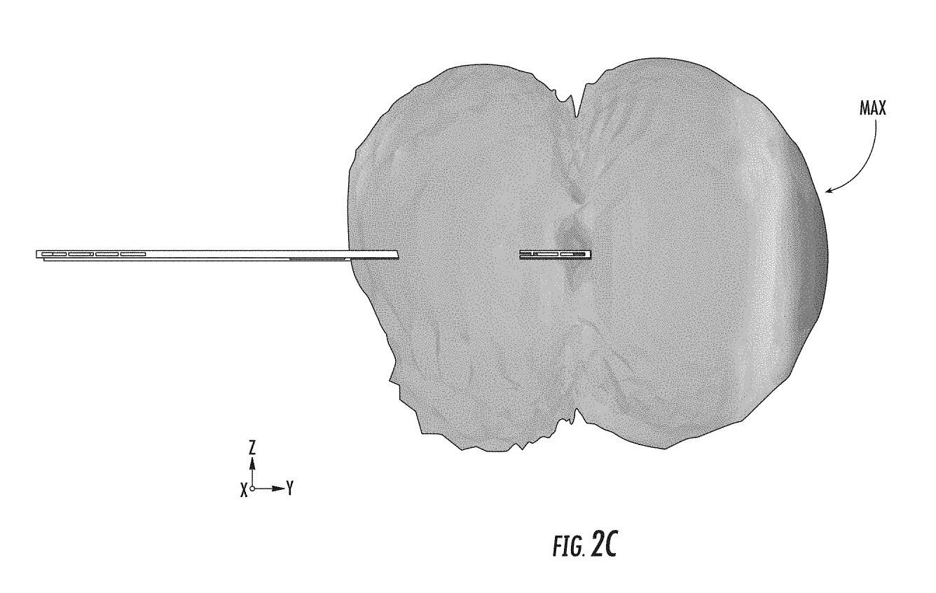

In some embodiments, antenna elements 120 are slot antenna elements, although those having skill in the art will recognize that any of a variety of other types of antenna elements can be used as antenna elements 120 to achieve similar performance. In any configuration, in some embodiments, each of antenna elements 120 in sub-arrays 101-1-101-i exhibit an end-fire radiation pattern. As illustrated in FIGS. 2A-2C, for example, radiations patterns for antenna array 100 can exhibit a maximum signal gain, generally designated MAX, in an end-fire direction. Alternatively, in other embodiments, elements with broadside radiation patterns are used. Referring to FIGS. 1A-1C, sub arrays positioned along a common one of edges 111-114 can have similar radiation patterns. In this regard, for example, in some embodiments, first and second sub-arrays 101-1 and 101-2 either are both configured to produce an end-fire radiation pattern or are both configured to produce a broadside radiation pattern. In addition, in some embodiments, combining sub-arrays from different edges can be used to generate a radiation pattern in a corner direction.

Regardless of the particular configuration of antenna elements 120 individually and/or sub-arrays 101-1 through 101-i, in some embodiments, the system is configured to switch between sub-arrays 101-1 through 101-i and/or use a progressive phase shift to scan each of sub-arrays 101-1 through 101-i. Stated otherwise, in some embodiments, each of sub-arrays 101-1 through 101-i is an independent antenna array, and the beam can be scanned in each of sub-arrays 101-1 through 101-i individually and/or phasing can be used to multiple antenna elements 120 in different sub-arrays. Alternatively or in addition, diversity can be provided between subarrays 101-1 through 101-i.

In configurations in which sub-arrays 101-1 through 101-i are operable simultaneously, an aggregate response can be generated by the combination from those sub-arrays. In some embodiments, for example, the feeds to the individual arrays have phase control that is controlled digitally in a transceiver 150. In some embodiments, this phase control includes multiple input/multiple output (MIMO) optimization, with different arrays pointing different directions for signals having multiple angles of arrival, such as due to environmental reflection from a single base station or signals from multiple base stations simultaneously. Alternatively or in addition, in some embodiments, the phase control among multiple sub-arrays can be used to obtain greater gain in a single direction. Furthermore, although some exemplary embodiments that use phase shifting as a mechanism for steering a signal beam generated by antenna array 100, those having ordinary skill in the art will recognize that any of a variety of other configurations for antenna array 100 that provide beam scanning can similarly be implemented with the systems, devices, and methods of the present subject matter.

In any configuration, the central processor can be configured to control whether sub-arrays 101-1 through 101-i are aligned for digital beam-forming or to point them in different directions when there is significant multi-path, whichever provides the best communications link. In standard MIMO at low frequencies, the antenna patterns are mostly fixed by the physical design, so the MIMO antennas are designed with different configurations and thus different patterns to support good MIMO operation. Such antenna elements cannot be used for good beam forming in most directions because their patterns cannot be aligned. In contrast, antenna array 100 according the present subject matter enables both good beam forming and good MIMO operation because the pattern of each of sub-arrays 101-1 through 101-i is controllable. As a result, the generation of an aggregate response from sub-arrays 101-1 through 1014 can provide redundancy in the radiation patterns such that shadowing effects, such as those caused by a user's head or hand, are minimized.

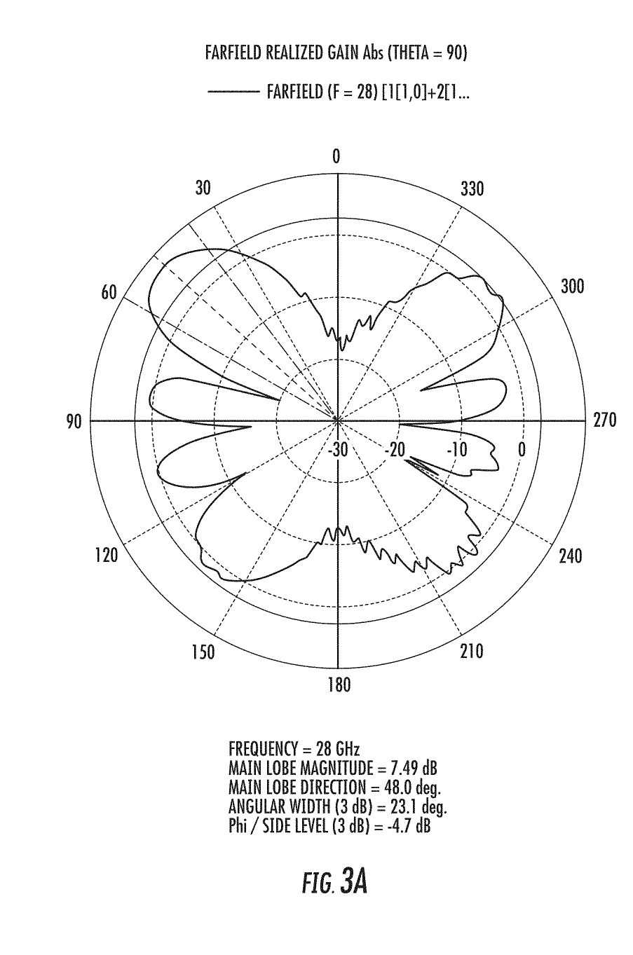

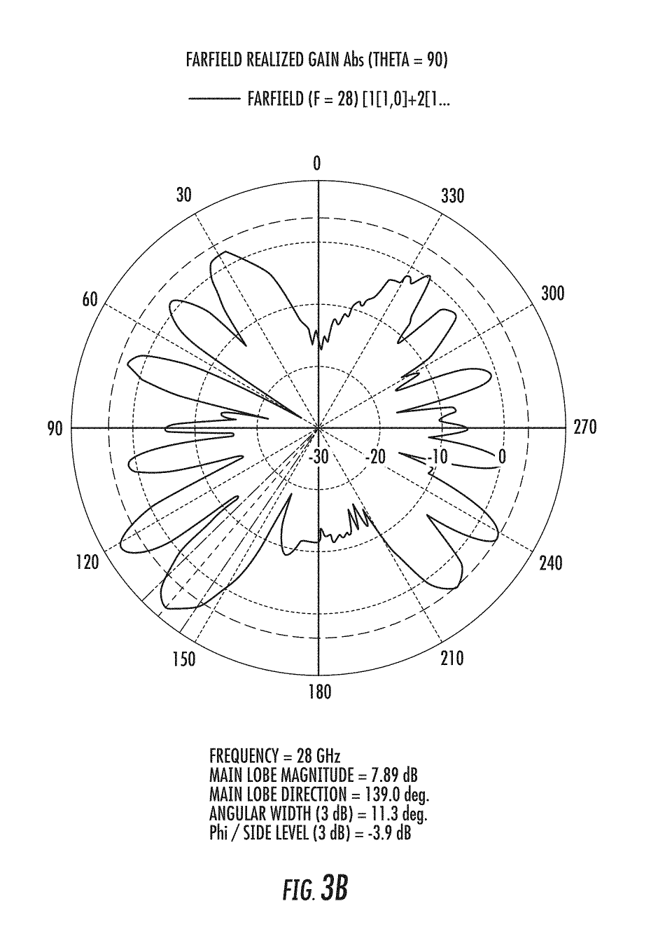

FIG. 3A illustrates a maximum scan angle in an embodiment in which only one of sub-arrays 101-1 through 101-i is active, which can include four of antenna elements 120 in the configuration illustrated in FIGS. 1A-1C. FIG. 3B illustrates the maximum scan angle in an embodiment in which multiple adjacent sub-arrays are active In some embodiments, for example, two of sub-arrays 101-1 through 101-i including eight total elements along one of first through fourth edges 111-114 of the mobile device are active. As can be seen, where multiple sub-arrays are active, the magnitude of the grating lobe can be increased, such as from 7.49 dB to 7.89 dB in this example, although the angular width of the main lobe is diminished, and the magnitudes of the sidelobes are also comparatively higher. That being said, in some embodiments, the sidelobes can be reduced by a kind of beamforming algorithm.

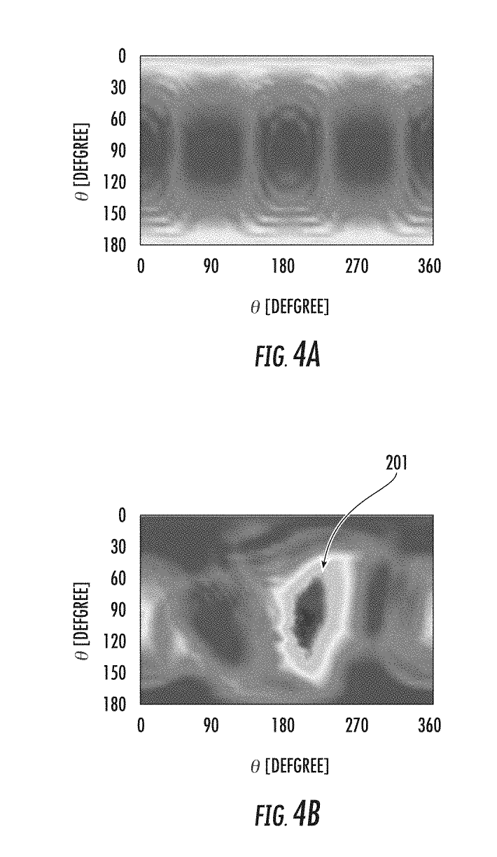

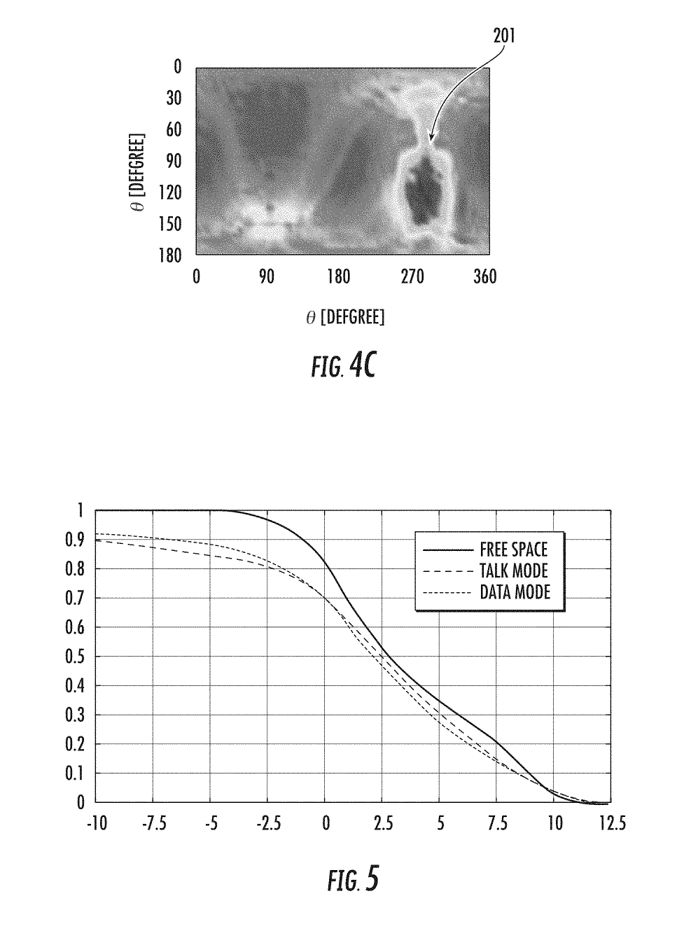

The proposed antenna array 100 has been simulated in free space, talk, and data modes with a phantom. The results of the simulations are shown as total scan patterns for all of the sub-arrays and all of the scan angles in FIGS. 4A-4C. The shadowing from the human, generally designated 201, can clearly be seen in FIG. 4B and FIG. 4C for talk and data modes, however the radiation pattern intensity over the remaining coverage region is stronger than in the free space case shown in FIG. 4A. The coverage efficiency computed from the total scan patterns shown in FIGS. 4A-4C is shown in FIG. 5. It can clearly be seen that for the gain values over 0 dBi, the coverage efficiency has similar values for all of the simulation setups.

The present subject matter can be embodied in other forms without departure from the spirit and essential characteristics thereof. The embodiments described therefore are to be considered in all respects as illustrative and not restrictive. Although the present subject matter has been described in terms of certain preferred embodiments, other embodiments that are apparent to those of ordinary skill in the art are also within the scope of the present subject matter.

What is claimed is:

1. An antenna array system comprising:
a plurality of antenna sub-arrays spaced apart from one another about a mobile device chassis, wherein each of the antenna sub-arrays comprises one or more antenna element; and
wherein one or more of the plurality of antenna sub-arrays is selectively addressable to generate an aggregate response among a combination of the plurality of antenna sub-arrays to steer one or more signal beam in a desired direction.

2. The system of claim 1, wherein the plurality of antenna sub-arrays is positioned in a ring about a perimeter edge of the mobile device chassis.

3. The system of claim 1, wherein the plurality of antenna sub-arrays is positioned at or near corners of the mobile device chassis.

4. The system of claim 3, wherein one of the plurality of sub-arrays is positioned at or near each end of each edge of the mobile device chassis.

5. The system of claim 1, wherein each of the antenna sub-arrays comprises four antenna elements.

6. The system of claim 1, wherein each of the plurality of antenna sub-arrays comprises an independent antenna array, wherein a respective one of the one or more signal beam is individually steerable by each of the plurality of the antenna sub-arrays.

7. The system of claim 1, wherein each of the plurality of antenna sub-arrays is connected to a transceiver that is configured to generate the aggregate response from a combination of two or more of the plurality of antenna sub-arrays.

8. The system of claim 1, wherein the plurality of antenna sub-arrays is selectively addressable to reduce shadowing effects from a user.

9. A method for operating an antenna array, the method comprising:
selectively addressing one or more of a plurality of antenna sub-arrays spaced apart from one another about a mobile device chassis to generate an aggregate response among a combination of the plurality of antenna sub-arrays; and
steering one or more signal beam from the one or more of the plurality of antenna sub-arrays in a desired direction.

10. The method of claim 9, wherein the plurality of antenna sub-arrays is positioned in a ring about a perimeter edge of the mobile device chassis.

11. The method of claim 9, wherein the plurality of antenna sub-arrays comprises eight sub-arrays positioned at or near corners of the mobile device chassis.

12. The method of claim 9, wherein each of the antenna sub-arrays comprises four antenna elements.

13. The method of claim 9, wherein steering the one or more signal beam comprises switching among the plurality of antenna sub-arrays.

14. The method of claim 9, wherein each of the plurality of antenna sub-arrays comprises an independent antenna array, wherein steering the one or more signal beam comprises individually steering a respective one of the one or more signal beam by each of the plurality of the sub-arrays.

15. The method of claim 9, wherein each of the plurality of antenna sub-arrays comprises an independent phased antenna array, wherein steering the one or more signal beam comprises phasing multiple elements in different ones of the plurality of antenna sub-arrays.

16. The method of claim 15, wherein steering the one or more signal beam comprises generating the aggregate response from a phased combination of two or more of the plurality of antenna sub-arrays.

17. The method of claim 15, wherein steering the one or more signal beam comprises reducing shadowing effects from a user.
